(19) United States
(12) Patent Application Publication
(10) Pub. No.: US 2021/0300339 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Gaku SHIMAMOTO, Saitama (JP); Junpei NOGUCHI, Saitama (JP); Yuta TAKADA, Tokyo (JP); Ryoma TAGUCHI, Tokyo (JP)

(73) Assignee: HONDA MOTOR CO., LTD., Tokyo (JP)

(21) Appl. No.: 17/211,427

(22) Filed: Mar. 24, 2021

(30) Foreign Application Priority Data
Mar. 30, 2020 (JP) 2020-061634

(51) Int. Cl. B60W 30/06; G08G 1/14; B60W 60/00; B60W 50/14

(52) U.S. Cl. CPC B60W 30/06; G08G 1/148; B60W 2050/146; B60W 60/0059; B60W 50/14; G08G 1/142

(57) ABSTRACT

A parking lot management device which manages a parking lot, includes a determination unit which determines whether to restrict exit of the vehicle from the parking lot based on an entry traveling state which is a traveling state of the vehicle to be a target of exit when entering the parking lot and an exit traveling state which is a traveling state of the vehicle to be a target of exit when exiting from the parking lot when there is a request to make the vehicle exit from the parking lot, and a processor which restricts the exit of the vehicle from the parking lot based on a determination result of the determination unit.

### CROSS-REFERENCE TO RELATED APPLICATIONS

The present application claims the benefit of priority of Japanese Patent Application No. 2020-061634, filed on Mar. 30, 2020, the content of which is incorporated herein by reference.

### TECHNICAL FIELD

The present invention relates to an accommodation area management device which manages an accommodation area capable of accommodating a moving body.

### BACKGROUND

In a recent year, a parking management system which manages a parking lot where a vehicle (that is, a self-propelled vehicle) equipped with an automatic traveling device can be parked has been known (see, for example, JP-A-2007-219738).

### SUMMARY

From a viewpoint of effectively utilizing an accommodation area for accommodating a moving body such as a vehicle, for example, it is conceivable to allow both a moving body (that is, manually moving) which moves based on a user operation and a moving body (that is, self-propelled) which automatically moves to be accommodated. However, when moving objects having different moving states can coexist in the accommodation area, for example, it is conceivable that a processing load of an accommodation area management device which manages the accommodation area will increase when an event such as a difference in the moving state of the moving body when entering the accommodation area and when exiting from the accommodation area occurs. Therefore, there is room for improvement in that respect.

The present invention provides accommodation area management device which makes it possible to reduce a processing load of an accommodation area management device which manages an accommodation area in which vehicles having different moving states may coexist.

A first embodiment of the present invention is an accommodation area management device which manages an accommodation area capable of accommodating a moving body, comprising:

a processor which restricts a second movement state which is a moving state of the moving body when exiting from the accommodation area based on a first movement state which is a moving state of the moving body when entering the accommodation area when there is a request to make the moving body exit from the accommodation area.

A second embodiment of the present invention is an accommodation area management device which manages an accommodation area capable of accommodating a moving body, comprising:

a determination unit which determines whether to restrict exit of the moving body from the accommodation area based on a first movement state which is a movement state of the moving body when entering the accommodation area and a second movement state which is a movement state of the moving body when exiting from the accommodation area when there is a request to make the moving body exit from the accommodation area; and

a processor which restricts the exit of the moving body from the accommodation area based on a determination result of the determination unit.

According to the present invention, it is possible to reduce the processing load of the accommodation area management device which manages the accommodation area in which vehicles having different moving states may coexist.

### BRIEF DESCRIPTION OF DRAWINGS

FIG. 1 is a diagram illustrating an example of a configuration of a vehicle system of an embodiment.

FIG. 2 is a diagram illustrating an example of a parking lot managed by a parking lot management device.

FIG. 3 is a diagram illustrating an example of a configuration of the parking lot management device.

FIG. 4 is a diagram illustrating an example of a parking space status table.

FIG. 5 is a diagram illustrating an example of whether exit is possible for each combination of an entry traveling state and an exit traveling state.

FIG. 6 is a flowchart illustrating an example of processing performed by the parking lot management device.

### DESCRIPTION OF EMBODIMENT

Hereinafter, an embodiment of an accommodation area management device of the present invention will be described with reference to the accompanying drawings. In the following embodiment, an example will be described in which a moving body in the present invention is a vehicle and an accommodation area in the present invention is a parking lot. Further, in the following embodiment, an example in which the accommodation area management device of the present invention is used as a parking lot management device for managing a parking lot will be described.

Vehicle System

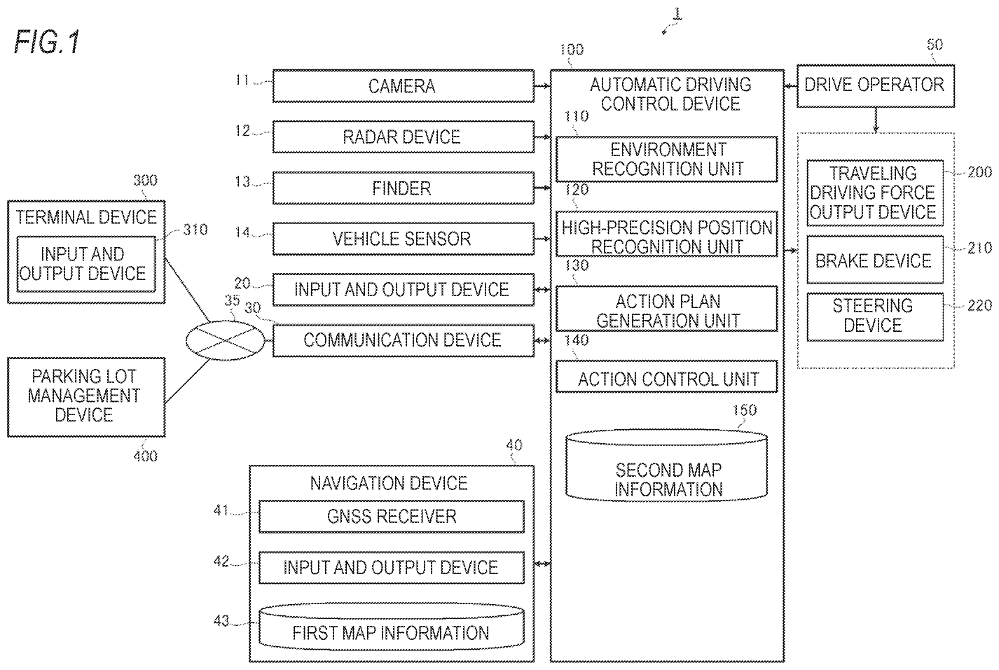

First, a vehicle of the embodiment will be described. In FIG. 1, a vehicle system 1 is mounted on a vehicle having an automatic driving function of a so-called automatic driving level “4” or higher. A vehicle (hereinafter, also referred to as vehicle M) equipped with the vehicle system 1 is a vehicle including a drive source (for example, traveling driving force output device 200) and wheels (for example, two wheels, three wheels, or four wheels) including driving wheels driven by the power of the drive source. The drive source of the vehicle M is, for example, an electric motor. Further, the drive source of the vehicle M may be an internal combustion engine such as a gasoline engine or a combination of an electric motor and an internal combustion engine.

As illustrated in FIG. 1, the vehicle system 1 includes a camera 11, a radar device 12, a finder 13, a vehicle sensor 14, an input and output device 20, a communication device 30, a navigation device 40, a drive operator 50, an automatic driving control device 100, the traveling driving force output device 200, a brake device 210, and a steering device 220. Each of those devices is communicably connected to each other by a wired or wireless communication network. The communication network connecting each of those devices is, for example, Controller Area Network (CAN).

The camera 11 is a digital camera which photographs the periphery (for example, in front of vehicle M) of the vehicle M and outputs image data obtained by the photographing to the automatic driving control device 100. The radar device 12 is, for example, a radar device using radio waves in a millimeter wave band, detects a position of an object in the vicinity (for example, in front of, behind, and to the side of vehicle M) of the vehicle M, and outputs the detection result to the automatic driving control device 100.

The finder 13 is, for example, Laser Imaging Detection and Ranging (LIDAR). The finder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication intensity) of the radio wave used by the communication device 30, described later, for communication. The vehicle sensor 14 outputs the detection result of each sensor to the automatic driving control device 100 or the like.

The input and output device 20 includes an output device which outputs various kinds of information to a user of the vehicle M and an input device which accepts various input operations from the user of the vehicle M. The output device of the input and output device 20 is, for example, a display which displays based on a processing result of the automatic driving control device 100. The output device may be a speaker, a buzzer, an indicator light, or the like. The input device of the input and output device 20 is, for example, a touch panel or an operation button (key, switch, or the like) which outputs an operation signal corresponding to an input operation received from a user to the automatic driving control device 100.

The communication device 30 is connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, a terminal device 300 carried by a user of the vehicle M, a parking lot management device 400 which manages a parking lot PA where the vehicle M can be parked. The terminal device 300 is, for example, a smartphone or a tablet terminal and is an electronic device connected to the network 35 and including an input and output device 310. The input and output device 310 is, for example, a display which displays various information to a user, a touch panel which accepts a user's input operation, and the like. The parking lot PA and the parking lot management device 400 will be described below.

The navigation device 40 includes a Global Navigation Satellite System (GNSS) receiver 41 and an input and output device 42. Further, the navigation device 40 includes a storage device (not illustrated) such as a flash memory and first map information 43 is stored in this storage device. The first map information 43 is, for example, information representing a road shape by a link indicating a road and a node connected by the link. Further, the first map information 43 may include information representing the curvature of the road and the Point Of Interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information to a user of the vehicle M and an input device which accepts various input operations from a user of the vehicle M. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

For example, the navigation device 40 determines a route (hereinafter, also referred to as a route on the map) from the position of the vehicle M specified by the GNSS receiver 41 to a destination input by the user with reference to the first map information 43. Then, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by the function of the terminal device 300. Also, for example, the communication device 30 may transmit information indicating the position of the vehicle M and the destination input by a user to a server device (navigation server) outside the vehicle system 1 and the function of the navigation device 40 may be realized by this server device.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction of the steering wheels.

Automatic Driving Control Device

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like to which each functional unit (for example, high-precision position recognition unit 120) of the automatic driving control device 100 can access and second map information 150 is stored in this storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the lane in the parking lot PA, the position of each parking space, and the like from the parking lot management device 400. Then, the automatic driving control device 100 updates the second map information 150 so as to incorporate the received in-parking-lot map information into the second map information 150. As a result, the automatic driving control device 100 can specify the position of each parking space in the parking lot PA with reference to the second map information 150.

The environment recognition unit 110 performs sensor fusion processing on information acquired by a part or all of the camera 11, the radar device 12, and the finder 13, in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the Central Processor (CPU) executing a predetermined program (software). Further, a part or all of the functional units of the automatic driving control device 100 may be realized by hardware such as Large Scale Integration (LSI), Application Specific Integrated Circuit (ASIC), Field-Programmable Gate Array (FPGA), Graphics Processor (GPU), and for example, the storage device for storing the second map information 150 and the high-precision position recognition unit 120 may be realized by a Map Positioning Unit (MPU). Further, a part or all of the functional units of the automatic driving control device 100 may be realized by the cooperation of software and hardware.

Parking Lot Managed by Parking Lot Management Device

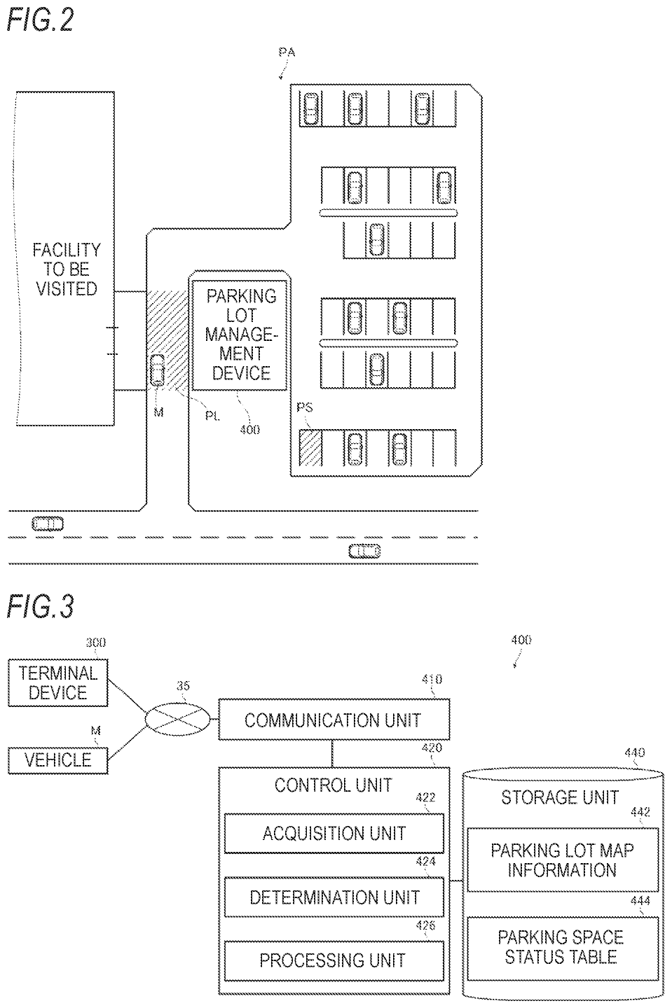

Next, an example of the parking lot PA will be described with reference to FIG. 2. As illustrated in FIG. 2, the parking lot PA is a parking lot managed by the parking lot management device 400 and is an automatic valet parking type parking lot attached to a visited facility to be visited by a user. The parking lot PA includes a plurality of parking spaces PS where a vehicle (for example, vehicle M) can be accommodated and a platform PL provided right before the plurality of parking spaces PS. Hereinafter, an example in which a user of the vehicle M uses the parking lot PA will be described.

Before using the parking lot PA, the user of the vehicle M makes a reservation (hereinafter, also referred to as parking reservation) for using the parking lot PA to the parking lot management device 400 which manages the parking lot PA by using the terminal device 300 or the like. For example, the user of the vehicle M inputs a date and time when the parking lot PA is used and a piece of identification information (for example, vehicle ID described below) of the vehicle M into the terminal device 300 or the like and transmits this information to the parking lot management device 400, whereby making a parking reservation. Then, at the reserved date and time, the user of the vehicle M will park the vehicle M in the parking lot PA. However, in this case, the vehicle M can be parked by using one of following two methods.

A first method is to park the vehicle M by automatic driving. In this case, the user of the vehicle M drives the vehicle M to the plat arm PL and gets off from the vehicle M on platform PL. After the user gets off the vehicle M, the vehicle M automatically drives and starts a self-propelled entry event to move to a predetermined parking space PS in the parking lot PA. For example, the user of the vehicle M uses the terminal device 300 to send a start request for the self-propelled entry event to the parking lot management device 400. In response to this start request, the parking lot management device 400 instructs vehicle M to move to a predetermined parking space PS. Following this instruction, the vehicle M moves from the parking lot management device 400 to the designated parking space PS while receiving guiding by the parking lot management device 400 and sensing with the camera 11, the radar device 12, the finder 13, or the like.

A second method is to park the vehicle M by manual driving. In this case, for example, the user of vehicle M drives the vehicle M to an empty parking space PS in the parking lot PA without getting off from the vehicle M on the platform PL and parks the vehicle M to the parking space PS. That is, in this case, the user of the vehicle M dares to park the vehicle M by manual driving without using the automatic driving function of the vehicle M. When the vehicle M is parked by manual driving in this way, it is desirable to notify the parking lot management device 400 of the parking position (for example, information indicating parked parking space PS). In this way, the parking lot management device 400 can grasp the parking position of the vehicle M even when the vehicle M is parked by manual driving.

In addition, the user of the vehicle M can make the vehicle M exit from the parking lot PA by using one of following two methods. A first method is a method of making the vehicle M exit by automatic driving. In this case, the vehicle M performs automatic driving and performs a self-propelled exit event to move from the parking space PS to the platform PL. For example, the user of the vehicle M uses the terminal device 300 to send a start request for the self-propelled exit event to the parking lot management device 400. In response to this start request, the parking lot management device 400 instructs the vehicle M to move to the platform PL. According to this instruction, the vehicle M moves to the platform PL while receiving guiding by the parking lot management device 400 and sensing with the camera 11, the radar device 12, the finder 13, or the like. Then, the user of the vehicle M gets on the vehicle M on the platform PL and leaves the parking lot PA.

A second method is a method of making. the vehicle M exit by manual driving. In this case, the user of the vehicle M, for example, goes to the parking space PS where the vehicle M is parked and gets on the vehicle M there. Then, the user of vehicle M performs manual driving and leaves the parking lot PA as it is. However, although details will be described below, when an entry traveling state which is the traveling state at the time of entry is different from an exit traveling state which is the traveling state at the time of exit, the vehicle parked in the parking lot PA may be restricted from exiting from the parking lot PA.

In addition, the vehicle M can carry out re-parking, so-called “reparking”, in which the parking position is changed to another parking position while parking at the parking lot PA. This repark is appropriately carried out by an instruction from the parking lot management device 400 or by voluntary automatic driving by the vehicle M itself.

Parking Lot Management Device

Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, a determination unit 424, and a processor 426. Each component of the control unit 420 is realized, for example, by a hardware processor such as a CPU executing a program (software). Some or all of those components may be realized by hardware (circuit part; including circuitry) such as LSI, ASIC, FPGA, and GPU, or may be realized by collaboration between software and hardware. The program may be stored in advance in a storage device (a storage device including a non-transient storage medium) such as an HDD or a flash memory or the program may be stored in a removable storage medium (non-transient storage medium) such as a DVD or a CD-ROM and installed by attaching the storage medium to a drive device.

Information such as parking lot map information 442 and parking space status table 444 is stored in the storage unit 440. The storage unit 440 is realized by an HDD, a flash memory, or the like. The parking lot map information 442 is information which geometrically represents the structure of the parking lot PA and includes information such as coordinates for each parking space PS. The parking space status table 444 will be described below.

The communication unit 410 wirelessly (for example, network 35) communicates with a vehicle in the parking lot PA, a vehicle (for example, vehicle M) to enter the parking lot PA, and a terminal device (for example, terminal device 300) of a user of the vehicle. The control unit 420 controls to manage the parking lot PA by using the information acquired by the communication unit 410 and the information stored in the storage unit 440.

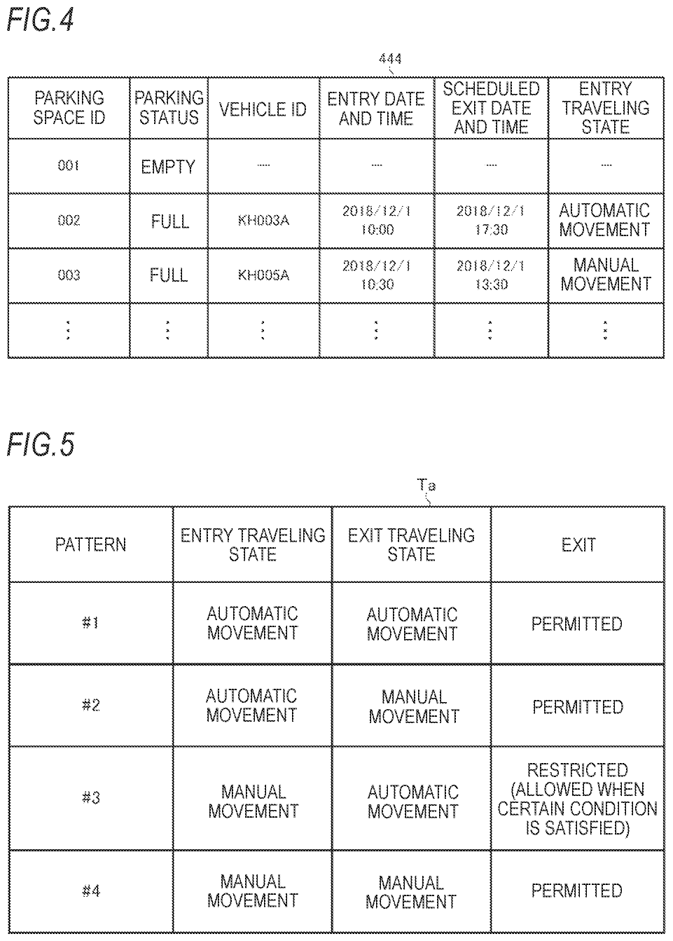

The acquisition unit 422 acquires the position information of a vehicle (for example, a parked vehicle) in the parking lot PA, for example, via the communication unit 410. This position information is stored, for example, in the format of the parking space status table 444. As illustrated in FIG. 4, the parking space status table 444 stores, for example, information indicating each of the parking space ID, a parking status, the vehicle ID, an entry time, a scheduled entry time, and the entry traveling state in association with each other.

The parking space ID is an identifier (identification information) which identifies each parking space PS in the parking lot PA. The parking status indicates whether any vehicle is parked in the corresponding parking space PS. The parking status is, for example, “full” when a vehicle is parked and “empty” when no vehicle is parked. The vehicle ID is an identifier (identification information) of each vehicle, for example, a vehicle number or a vehicle body number. In the parking space status table 444, the vehicle ID is stored in association with the parking space PS in which the parking status is “full” and indicates the vehicle parked in the parking space PS.

Further, in the parking space status table 444, the entry date and time is stored in association with the parking space PS in which the parking status is “full” and indicates the date and time when the vehicle is parked in the parking space PS. The scheduled exit date and time is stored in association with the parking space PS in which the parking status is “full” and indicates the date and time when the parked vehicle is scheduled to exit (leave) from the parking space PS or the parking lot PA.

In addition, the acquisition unit 422 acquires information indicating the traveling state (hereinafter, also referred to as the entry traveling state) of the vehicle when the vehicle enters the parking lot PA, and then the acquisition unit 422 stores, for example, the acquired information indicating the entry traveling state in the parking space status table 444 in association with the vehicle ID of the vehicle. The entry traveling state is an example of a first movement state of the present invention.

Specifically, the acquisition unit 422 acquires information indicating whether it is “manual movement” or “automatic movement” as information indicating the entry traveling state. Here, the manual movement is the movement of the vehicle based on a user operation, that is, the movement of the vehicle realized by a manual operation by a user. Further, the automatic movement is the movement of the vehicle under the control of the parking lot management device 400 or the vehicle itself, that is, the movement of the vehicle realized by the automatic driving.

For example, it is assumed that a user of the vehicle M drives the vehicle M to an empty parking space PS in a parking lot PA without getting off from the vehicle M on the platform PL, and parks the vehicle M to the empty parking space PS. In this case, the acquisition unit 422 acquires information indicating “manual movement” as information indicating the entry traveling state of the vehicle M. Then, the acquisition unit 422 stores the acquired information indicating “manual movement” in the parking space status table 444 in association with the vehicle ID of the vehicle M.

On the other hand, it is assumed that the user of the vehicle M parks the vehicle M in the parking lot PA by getting off from the vehicle M on the platform PL and causing the vehicle M to perform a self-propelled entry event. In this case, the acquisition unit 422 acquires the information indicating “automatic movement” as the information indicating the entry traveling state of the vehicle M. Then, the acquisition unit 422 stores the acquired information indicating “automatic movement” in the parking space status table 444 in association with the vehicle ID of the vehicle M.

The acquisition unit 422 communicates with, for example, a vehicle (for example, vehicle M) entering the parking lot PA, a terminal device (for example, terminal device 300) of a user of the vehicle, equipment (for example, monitoring camera in parking lot PA) in the parking lot PA, or the like via the communication unit 410. Then, the acquisition unit 422 acquires information indicating the entry traveling state of the vehicle based on the status of the vehicle when it enters the parking lot PA and the information received from the user of the vehicle before entry. As a result, based on the status of the vehicle when it enters the parking lot PA and the information received from the user of the vehicle before entry, the parking lot management device 400 can acquire information indicating the entry traveling state of the vehicle.

Specifically, for example, the acquisition unit 422 may acquire information indicating “automatic movement” as information indicating the entry traveling state of the vehicle when the user does not get off on the platform PL. Whether the user gets off the vehicle on the platform PL can be determined from the video of the monitoring camera in the parking lot PA. Also, for example, before the vehicle enters the parking lot PA (for example, when making a parking reservation), the parking lot management device 400 may receive in advance from the user of the vehicle whether to make the vehicle enter the parking lot by manual movement or automatic movement.

Further, the acquisition unit 422 acquires information indicating the traveling state (hereinafter, also referred to as the exit traveling state) of the vehicle when exiting from the parking lot PA. The exit traveling state is an example of a second movement state of the present invention. Specifically, the acquisition unit 422 acquires information indicating “manual movement” or “automatic movement” as information indicating the exit traveling state. For example, the parking lot management device 400 receives a request (hereinafter, also referred to as an exit request) for making the vehicle exit from the parking lot PA from a user of the vehicle. The exit request includes, for example, the vehicle to be made to exit and information on whether to make the vehicle exit by manual movement or automatic movement. For example, the user can access the parking lot management device 400 with the terminal device 300 or the like and notify the parking lot management device 400 of this information to make the exit request.

For example, it is assumed that the parking lot management device 400 receives an exit request from a user of the vehicle M to make the vehicle M exit by manual movement. In this case, the acquisition unit 422 may acquire information indicating “manual movement” as information indicating the exit traveling state of the vehicle M. On the other hand, it is assumed that the parking lot management device 400 receives an exit request from a user of the vehicle M to make the vehicle M exit by automatic movement. In this case, the acquisition unit 422 may acquire information indicating “automatic movement” as information indicating the exit traveling state of the vehicle M. The exit request for making the vehicle M exit by automatic movement may be the start request for the self-propelled exit event described above.

In addition, when the parking lot management device 400 receives an exit request to make a vehicle which has not been registered to the effect that it has entered the parking lot PA exit, the acquisition unit 422 may acquire information indicating “manual movement” as information indicating the exit traveling state of the vehicle. For example, when the vehicle M is parked in the parking lot PA by automatic driving based on the acceptance of a request to start a self-propelled entry event, the parking lot management device 400 registers in a predetermined management table that the vehicle M has entered the parking lot PA. On the other hand, when the vehicle M is parked in the parking lot PA by manual driving, the fact that the vehicle M has entered the parking lot PA is not registered in the predetermined management table. When the parking lot management device 400 receives an exit request to make the vehicle which has not been registered to the effect that it has entered the parking lot PA exit in this way, the acquisition unit 422 may acquire information indicating “manual movement” as information indicating the exit traveling state of the vehicle.

Also, not limited to the above example, the acquisition unit 422 may acquire information indicating the exit traveling state by communicating with a vehicle or equipment (for example, a monitoring camera in parking lot PA) in the parking lot PA via the communication unit 410. For example, when vehicle M is moving towards the platform PL even though the vehicle M does not perform a self-propelled exit event (for example, the parking lot management device 400 has not accepted the request to start the self-propelled exit event for the vehicle M), the acquisition unit 422 may acquire information indicating “manual movement” as information indicating the exit traveling state of the vehicle M. Also, for example, when the parking lot management device 400 communicates with the vehicle, equipment, or the like in the parking lot PA and checks the parking space PS where a certain vehicle has moved and becomes empty, the parking lot management device 400 may allow another vehicle to be parked in this parking space PS.

When there is an exit request, the determination unit 424 determines whether to restrict the exit of the vehicle from the parking lot PA based on the entry traveling state and the exit traveling state of the vehicle to be a target of exit. The determination unit 424 determines that, for example, when the entry traveling state and the exit traveling state do not match, the exit of the vehicle from the parking lot PA is restricted.

The processor 426 has a function capable of restricting the exit of the vehicle determined to be restricted from exiting from the parking lot PA when it is determined by the determination unit 424 to restrict the exit. For example, When it is determined that the exit of the vehicle M is restricted, the processor 426 restricts the exit of the vehicle M by not instructing the vehicle M to move or instructing the vehicle M not to move, in such a manner that the processor 426 restricts the exit of the vehicle M.

The method of restricting the exit is not limited to this. For example, an exit gate which can be opened or closed may be provided at an exit of the parking lot PA so that the exit gate will not be opened when a vehicle which is determined to be restricted from exiting comes to the exit. Further, the vehicle which is determined to be restricted from exiting may not be directed to the exit of the parking lot PA, but may go the round of the parking lot PA.

As described above, the parking lot PA is a parking lot where both a manually moved vehicle and an automatically moved vehicle can enter. Since the parking lot management device 400 does not need to perform various processes for realizing automatic valet parking for a manually moved vehicle, it can be parked with a smaller processing load than an automatically moved vehicle. Then, for example, when a vehicle which has entered by manual movement can be excluded from the monitoring target for exiting by automatic movement on the assumption that it will exit by manual movement, the processing load of the parking lot management device 400 can be further reduced.

However, in this case, it is conceivable that some vehicles may not match the entry traveling state and the exit traveling state. Attempting to make such a vehicle exit from the parking lot PA may cause some trouble or it may be difficult to make the vehicle exit in the first place. Therefore, by restricting the exit from the parking lot PA of the vehicle whose entry traveling state and exit traveling state do not match, the parking lot management device 400 can reduce a processing load in managing the parking lot PA while performing stable management of the parking lot PA.

Further, as described above, the manually moved vehicle is considered to give less processing load to the system which realizes the automatic valet parking such as the parking lot management device 400 than the automatically moved vehicle. Therefore, it is conceivable to set a parking fee of the vehicle entering by manual movement lower than a parking tee of the vehicle entering by automatic movement. In this way, it is possible to set a fair parking fee in consideration of the processing load given to the system which realizes automatic valet parking such as the parking lot management device 400.

However, in this case, for example, it is conceivable that some users may try to use the automatic movement at the time of exit, although the vehicle enters by manual movement. It is not desirable to unconditionally make such a user's vehicle exit from the parking lot PA. Therefore, as described above, by restricting the exit of a vehicle in which the entry traveling state and the exit traveling state do not match from the parking lot PA, the parking lot management device 400 can also suppress the unconditional exit of such a user's vehicle from the parking lot PA.

On the other hand, the determination unit 424 determines that, for example, when the entry traveling state and the exit traveling state match, the exit of the vehicle from the parking lot PA is not restricted (that is, permitted). As a result, the parking lot management device 400 can make the vehicle whose entry traveling state and exit traveling state match exit from the parking lot PA smoothly. As a result, it is possible to improve the convenience of the user.

Further, the determination unit 424 may determine whether to restrict the exit of the vehicle according to the combination of the entry traveling state and the exit traveling state. Specifically, in the embodiment, as illustrated in a table Ta of FIG. 5, as a combination of the entry traveling state and the exit traveling. state, a pattern #1 in which the entry traveling state is “automatic movement” and the exit traveling state is “automatic movement”, a pattern #2 in which the entry traveling state is “automatic movement” and the exit traveling state is “manual movement”, a pattern #3 in which the entry traveling state is “manual movement” and the exit traveling state is “automatic movement”, and a pattern #4 in which the entry traveling state is “manual movement” and the exit traveling state is “manual movement” can be considered.

A vehicle in which the entry traveling state and the exit traveling state match corresponds to the pattern 41 or the pattern 44. For a vehicle whose entry traveling state and exit traveling state match, it is desirable to make the vehicle exit smoothly as described above. Therefore, the determination unit 424 determines that, when the vehicle to be made to exit corresponds to the pattern #1 or the pattern #4, the vehicle is allowed to be made to exit from the parking lot PA.

A vehicle in which the entry traveling state and the exit traveling state do not match corresponds to the pattern #2 or the pattern #3. However, for a vehicle which corresponds to the pattern #2, although the entry traveling state and the exit traveling state do not match, the user of the vehicle is responsible for making the vehicle exit by manual driving. Thus, as the parking lot management device 400, there is little need to dare to restrict the exit of the vehicle. Therefore, the determination unit 424 may determine that, when the vehicle to he made to exit corresponds to the pattern 42, the vehicle is allowed to be made to exit from the parking lot PA. As a result, the convenience of the user of the vehicle can be improved.

On the other hand, for the vehicle corresponding to the pattern 43, the entry traveling state and the exit traveling state do not match and the vehicle is made to exit by automatic movement. As a result, this leads to an increase in the processing load of the parking lot management device 400. For example, as described above, in the parking lot PA, when the vehicle M is parked by automatic driving, it is registered that the vehicle M has entered the parking lot PA, but when the vehicle M is parked by manual operation, it may not be registered that the vehicle M has entered the parking lot PA. In such a case, the vehicle M parked by manual driving is not registered in the parking lot management device 400 to the effect that it has entered the parking lot PA, and at least at the time of entry, the vehicle is not under the management of the parking lot management device 400. When attempting to make the vehicle M which is not under the management of such a parking lot management device 400 exit by automatic operation, for example, first of all, it is necessary to perform a process such as grasping the position of the vehicle M, and thus this may lead to an increase in the processing load of the parking lot management device 400.

In addition, when such a vehicle not under the management is attempted to be made to exit from the parking lot PA, some kind of failure may occur or it may be difficult to make the vehicle exit in the first place. Therefore, the determination unit 424 may determine that, when the vehicle to be made to exit corresponds to the pattern 43, the determination unit 424 restricts the exit of the vehicle from the parking lot PA. As a result, it is possible to reduce the processing load of the parking lot management device 400 in managing the parking lot PA while performing stable management of the parking lot PA.

Further, when the processor 426 restricts the exit of the vehicle from the parking lot PA, the processor 426 may notify the terminal device of the user of the vehicle that the exit is restricted via the communication unit 410. For example, when the processor 426 restricts the exit of the vehicle M, the processor 426 notifies the user of the vehicle M that the exit of the vehicle M has been restricted by sending a message or the like indicating that the exit of the vehicle M has been restricted to the terminal device 300. An example of this message is “Your vehicle entered manually, so it is not registered in the parking lot management device and the vehicle cannot exit by autonomous driving. If you wish to exit, please drive manually.” As a result, it is possible to notify the user of the vehicle whose exit is restricted that the exit is restricted. Therefore, it is possible to encourage a user of a vehicle whose exit is restricted to take some action.

Further, when the processor 426 restricts the exit of the vehicle from the parking lot PA, the processor 426 may allow the exit of the vehicle when a predetermined condition is satisfied. Here, the predetermined condition can be, for example, the acceptance of a billing operation for paying a predetermined fee. For example, in this case, when the parking lot management device 400 accepts a billing operation via a predetermined checkout device installed in the parking lot PA, a terminal device (for example, terminal device 300) of a user of the vehicle whose exit is restricted, or the like, the processor 426 allows the exit of the vehicle whose exit has been restricted. Based on the fact that the parking lot management device 400 has accepted the billing operation in this way, the processor 426 permits (that is, cancels the restriction) the exit of the vehicle whose exit has been restricted. As a result, it is possible to promote the billing operation of the user of the vehicle whose exit has been restricted. Therefore, it is possible to make it possible for the user of the vehicle whose exit has been restricted to bear the charge for using the parking lot management device 400, and thus it is possible to realize a fair parking fee in consideration of the processing load on the system which realizes automatic valet parking such as the parking lot management device 400. That is, a fair parking fee can be realized between a user who uses the system and a user who does not use the system.

However, regarding the parking fee (that is, the user who parked by automatic driving) when using the system and the parking fee (that is, the user who parked by manual driving) when not using the system, an administrator of the parking lot PA or the like may decide as appropriate. In addition, a vehicle whose exit restriction has been canceled under certain conditions may have a lower priority in the parking lot PA than a vehicle whose exit has not been restricted. Specifically, when a vehicle whose exit restrictions have been canceled and a vehicle whose exit has not been restricted are to be made to exit, the vehicle whose exit has not been restricted may be made to exit first (that is, the vehicle whose exit restriction has been canceled is made to wait during this period).

Further, the predetermined conditions are not limited to the acceptance of the billing operation and may be appropriately set by the administrator of the parking lot PA or the like. For example, the predetermined conditions may be the elapse of a predetermined time after entering the parking lot PA, the status of the parking lot PA (for example, parking lot PA is full), and the like.

In addition, the processor 426 may further perform various processes for managing the parking lot PA. For example, the processor 426 may determine the parking position of the vehicle entering the parking lot PA or may instruct the vehicle to move to the determined parking position, Further, the processor 426 may perform reparking, for example, when it becomes necessary to change (that is, repark) the parking position of the parked vehicle in the parking lot PA.

For example, the processor 426 may perform reparking to move the vehicle when a predetermined time has elapsed since the vehicle entered the parking lot PA. Specifically, the processor 426 may automatically move a vehicle whose predetermined time has passed after the entry date and time or a vehicle whose exit date and time has passed. As a result, it is possible to prevent the same vehicle from being parked in the same parking position for a long time, and thus it is possible to effectively utilize the parking lot PA.

Also, when the parking position of the vehicle to be parked in the parking lot PA is determined, the processor 426 may also determine a suitable route to its parking position and may use the communication unit 410 to send the determined route to the vehicle. In this case, in the vehicle which received the route, the action plan generation unit 130 generates an action plan (for example, a target track) based on the route and the action control unit 140 controls the vehicle to act according to this action plan.

Further, as a modification example of the embodiment, when an exit request is made, the processor 426 may restrict the exit traveling state of the vehicle to be made to exit based on the entry traveling state of the vehicle. For example, in this case, the exit traveling state may be restricted so that only the same traveling state as the entry traveling state is permitted as the exit traveling state. In this case, as described above, when the entry traveling state is “automatic movement”, both “automatic movement” and “manual movement” are permitted as the exit traveling state, whereas when the entry traveling state is “manual movement”, the exit traveling state may be restricted so that only “manual movement” is permitted as the exit traveling state. In this way, even when the exit traveling state is restricted based on the entry traveling state, the exit from the parking lot PA of the vehicle whose entry traveling state and exit traveling state do not match can be restricted. As a result, it is possible to reduce the processing load of the parking lot management device 400 in managing the parking lot PA while performing stable management of the parking lot PA.

Processing Flow

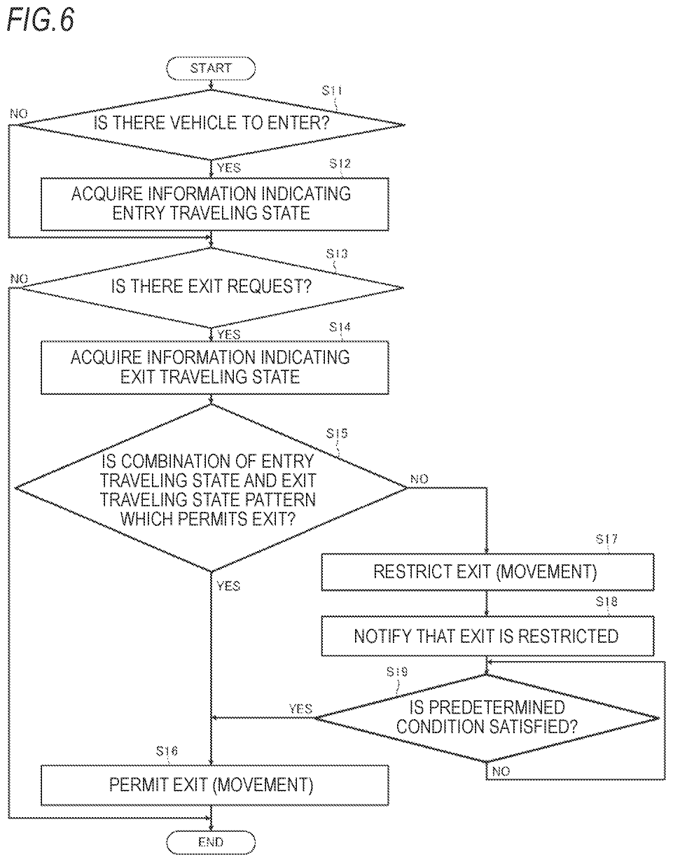

Next, an example of processing performed by the parking lot management device 400 will be described with reference to FIG. 6. The parking lot management device 400, for example, repeats the process illustrated in FIG. 6 at a predetermined cycle.

As illustrated in FIG. 6, the parking lot management device 400 first determines whether there is a vehicle to enter the parking lot PA (step S11). When there is no vehicle to enter the parking lot PA (NO in Step S11), the process proceeds to Step S13. When there is a vehicle to enter the parking lot PA (YES in Step S11), the parking lot management device 400 acquires information indicating the entry traveling state of the vehicle to enter (Step S12). As described above, when the parking lot management device 400 acquires the information indicating the entry traveling state of the vehicle to enter, the acquired information indicating the entry traveling state is stored in the parking space status table 444 or the like in association with the vehicle ID of the vehicle to enter.

Next, the parking lot management device 400 determines whether there is an exit request from a user (Step S13). As described above, for example, the user can make an exit request to the parking lot management device 400 by accessing the parking lot management device 400 with the terminal device 300 or the like. When there is no exit request (NO in Step S13), the parking lot management device 400 ends the process illustrated in FIG. 6. On the other hand, when there is an exit request (YES in Step S13), the parking lot management device 400 acquires information indicating an exit traveling state of the vehicle to be made to exit based on the exit request (Step S14).

Next, the parking lot management device 400 determines whether a combination of the entry traveling state and the exit traveling state of the vehicle to be made to exit is a pattern that permits the exit, that is, one of the above-described patterns #1, #2, or #4 (Step S15). When the combination of the entry traveling state and the exit traveling state of the vehicle to be made to exit is the pattern that permits the exit (YES in Step S15), the parking lot management device 400 permits the exit (for example, movement) of the vehicle to be made to exit (Step S16), and ends the process illustrated in FIG. 6.

On the other hand, when the combination of the entry traveling state and the exit traveling state of the vehicle to be made to exit is a pattern which restricts the exit, that is, the above-described pattern 43 (NO in Step S15), the parking lot management device 400 restricts the exit (for example, movement) of the vehicle to be made to exit (Step S17), and then the parking lot management device 400 notifies the user of the vehicle to be made to exit that the exit is restricted (Step S18). Also, in this case, the parking lot management device 400 may further notify the user that if he or she wishes to make the vehicle exit, he or she should perform the exit by manual driving, or that the exit by automatic driving becomes possible when a predetermined condition is satisfied. Those notifications may be given separately.

Then, the parking lot management device 400 determines whether the predetermined condition is satisfied (Step S19). In Step S19, for example, the parking lot management device 400 determines whether there has been a billing operation. When the predetermined condition is satisfied, for example, there is a billing operation (YES in Step S19), the parking lot management device 400 shifts to the process of Step S16. On the other hand, when the predetermined condition is not satisfied (NO in Step S19), for example, there is no billing operation, the parking lot management device 400 repeats the process in Step S19. In this case, since the process does not proceed to the process of Step S16, the restriction on the exit of the vehicle to be made to exit is maintained.

In addition to the processing illustrated in FIG. 6, for each vehicle parked in the parking lot PA, the parking lot management device 400 may determine whether an elapsed time from the time of entry is a predetermined time or more, and appropriately automatically move the vehicle whose elapsed time from the time of entry is the predetermined time or more. As a result, the parking lot management device 400 can forcibly make a vehicle which has been left in the parking lot PA for a long time exit from the parking lot PA. Also, for a vehicle which has been left in the parking lot PA for a long time, the parking lot management device 400 make the vehicle parked in the parking lot PA while automatically extending the parking time while considering the usage reservation status for the parking lot PA (for example, if there is an empty space in parking lot PA), and then the parking lot management device 400 may charge a user of the vehicle a parking fee considering the extended parking time.

As described above, when there is an exit request, based on the entry traveling state and the exit traveling state of the vehicle to be made to exit, the parking lot management device 400 determines whether to restrict the exit of the vehicle to be made to exit, and then the parking lot management device 400 can restrict the exit of the vehicle to be made to exit based on the determination result. As a result, the processing load for managing the parking lot PA can be reduced while the parking lot PA is stably managed.

The present invention is not limited to the embodiment described above and can be appropriately modified, improved, and the like.

For example, in the embodiment described above, an example in which the moving body is a vehicle is described, but the present invention is not limited to this. The idea of the present invention can be applied not only to a vehicle but also to a robot, a ship, an aircraft, or the like which has a drive source and can be moved by power of the drive source. Similarly, the accommodation area may be a hangar, a berth, a parking apron, or the like.

At least the following matters are described in this specification. The components and the like corresponding to those of the embodiment described above are shown in parentheses, but the present invention is not limited thereto.

(1) An accommodation area management device (parking lot management device 400) which manages an accommodation area (parking lot PA) capable of accommodating a moving body (vehicle M), including:

a processor (processor 426) which restricts a second movement state which is a moving state of the moving body when exiting from the accommodation area based on a first movement state which is a moving state of the moving body when entering the accommodation area when there is a request to make the moving body exit from the accommodation area.

According to (1), the second movement state at the time of exit can be restricted based on the first movement state at the time of entry of the moving body to be made to exit from the accommodation area. Therefore, the processing load of the accommodation area management device required for managing the accommodation area can be reduced.

(2) An accommodation area management device (parking lot management device 400) which manages an accommodation area (parking lot PA) capable of accommodating a moving body (vehicle M), including:

a determination unit (determination unit 424) which determines whether to restrict exit of the moving body from the accommodation area based on a first movement state which is a movement state of the moving body when entering the accommodation area and a second movement state which is a movement state of the moving body when exiting from the accommodation area when there is a request to make the moving body exit from the accommodation area; and

a processor (processor 426) which restricts the exit of the moving body from the accommodation area based on a determination result of the determination unit.

According to (2), the exit of the moving body from the accommodation area can be restricted based on the first movement state and the second movement state of the moving body to be made to exit from the accommodation area Therefore, the processing load of the accommodation area management device required for managing the accommodation area can be reduced.

(3) The accommodation area management device according to (2), where

the determination unit determines that the exit of the moving body from the accommodating area is not restricted when the first movement state and the second movement state match.

According to (3), the exit of the moving body in which the first movement state and the second movement state match is not restricted. Therefore, the moving body whose first movement state and second movement state match can be smoothly made to exit from the accommodation area.

(4) The accommodation area management device according to (2) or (3), where

the first movement state is manual movement based on a user operation, or automatic movement based on control of the accommodation area management device or the moving body.

According to (4), the moving body in which the manual movement based on the user operation or the automatic movement based on the control of the accommodation area management device or the moving body is the first movement state is allowed to enter the accommodation area, and thus effective use of the accommodation area can be achieved.

(5) The accommodation area management device according to (4), where

the determination unit determines to restrict the exit of the moving body from the containment area when the first movement state is the manual movement and the second movement state is the automatic movement based on the control of the accommodation area management device or the moving body.

According to (5), when the first movement state is manual movement and the second movement state is automatic movement, the exit of the moving body from the accommodation area is restricted. Therefore, it is possible to perform stable management of the accommodation area.

(6) The accommodation area management device according to any one of (2) to (5), where

the first movement state is acquired based on a situation of the moving body when entering the accommodation area, or information received from a user of the moving body before the moving body enters the accommodation area, and

the second movement state is acquired based on information received from the user of the moving body when there is a request to exit.

According to (6), the first movement state can be acquired from the situation of the moving body when entering the accommodation area or the information received from the user of the moving body before the moving body enters the accommodation area and the second movement state can be acquired based on the information received from the user of the moving body when there is a request to exit.

(7) The accommodation area management device according to any one of (2) to (6), further including:

a communication unit capable of communicating with a terminal device of a user of the moving body, wherein

the processor notifies the terminal device that the exit of the moving body is restricted via the communication unit when the processor restricts the exit of the moving body from the accommodation area.

According to (7), when the exit of the moving body from the accommodation area is restricted, the terminal device of the user of the moving body is notified that the exit of the moving body is restricted. Therefore, it is possible to encourage the user to take action.

(8) The accommodation area management device according to any one of (2) to (7), where

the processor permits the exit of the moving body from the accommodation area when a predetermined condition is satisfied when the processor restricts the exit of the moving body from the accommodation area.

According to (8), when the predetermined condition is satisfied, the moving body whose exit from the accommodation area is restricted is allowed to exit. Therefore, effective use of the accommodation area can be achieved.

(9) The accommodation area management device according to any one of (2) to (8), where

the moving body is automatically moved when a predetermined time is elapsed after the moving body enters the accommodation area.

According to (9), when a predetermined time elapses after the moving body enters the accommodation area, the moving body is moved. Therefore, effective use of the accommodation area can be achieved.

(10) The accommodation area management device according to any one of (1) to (9), where

the accommodation area is an area in which the moving body can be accommodated by manual movement based on the user operation and automatic movement based on the control of the accommodation area management device or the moving body.

According to (10), the accommodation area is an area in which the moving body can be accommodated by manual movement based on the user operation and automatic movement based on the control of the accommodation area management device or the moving body. Therefore, a variety of moving bodies can be accommodated, and thus the accommodation area can be effectively utilized.

What is claimed is:

1. An accommodation area management device which manages an accommodation area capable of accommodating a moving body, comprising:
a processor which restricts a second movement state which is a moving state of the moving body when exiting from the accommodation area based on a first movement state which is a moving state of the moving body when entering the accommodation area when there is a request to make the moving body exit from the accommodation area.

2. An accommodation area management device which manages an accommodation area capable of accommodating a moving body, comprising:
a determination unit which determines whether to restrict exit of the moving body from the accommodation area based on a first movement state which is a movement state of the moving body when entering the accommodation area and a second movement state which is a movement state of the moving body when exiting from the accommodation area when there is a request to make the moving body exit from the accommodation area; and
a processor which restricts the exit of the moving body from the accommodation area based on a determination result of the determination unit.

3. The accommodation area management device according to claim 2, wherein
the determination unit determines that the exit of the moving body from the accommodating area is not restricted when the first movement state and the second movement state match.

4. The accommodation area management device according to claim 2, wherein
the first movement state is manual movement based on a user operation, or automatic movement based on control of the accommodation area management device or the moving body.

5. The accommodation area management device according to claim 4, wherein
the determination unit determines to restrict the exit of the moving body from the containment area when the first movement state is the manual movement and the second movement state is the automatic movement based on the control of the accommodation area management device or the moving body.

6. The accommodation area management device according to claim 2, wherein
the first movement state is acquired based on a situation of the moving body when entering the accommodation area, or information received from a user of the moving body before the moving body enters the accommodation area, and
the second movement state is acquired based on information received from the user of the moving body when there is a request to exit.

7. The accommodation area management device according to claim 2, further comprising:
a communication unit capable of communicating with a terminal device of a user of the moving body, wherein
the processor notifies the terminal device that the exit of the moving body is restricted via the communication unit when the processor restricts the exit of the moving body from the accommodation area.

8. The accommodation area management device according to claim 2, wherein
the processor permits the exit of the moving body from the accommodation area when a predetermined condition is satisfied when the processor restricts the exit of the moving body from the accommodation area.

9. The accommodation area management device according to claim 2, wherein
the moving body is automatically moved when a predetermined time is elapsed after the moving body enters the accommodation area.

10. The accommodation area management device according to claim 1, wherein
the accommodation area is an area in which the moving body can be accommodated by manual movement based on the user operation and automatic movement based on the control of the accommodation area management device or the moving body.
